(19) United States
(12) Patent Application Publication
(10) Pub. No.: US 2017/0253325 A1
(43) Pub. Date: Sep. 7, 2017

(54) UNMANNED AERIAL VEHICLE (UAV) AND A METHOD OF IMPROVING THE PERFORMANCE THEREOF

(71) Applicant: Jianhua Zou, Guangzhou (CN)

(72) Inventor: Jianhua Zou, Guangzhou (CN)

(73) Assignee: Guangzhou Hitehome CO., LTD, Guangzhou City (CN)

(21) Appl. No.: 15/207,577

(22) Filed: Jul. 12, 2016

(30) Foreign Application Priority Data
Mar. 4, 2016 (CN) 201620169660. 7

(51) Int. Cl. B64C 27/00; B64C 27/08; B64C 39/02

(52) U.S. Cl. CPC B64C 27/006; B64C 39/024; B64C 27/08; B64C 2201/024; B64C 2201/108; B64C 2201/127; B64C 2201/042

(57) ABSTRACT

The present invention provides an unmanned aerial vehicle (UAV) such as a rotorcraft and a method of improving the performance thereof. The UAV is equipped with an inflated bag to prevent or alleviate property damage and personal injury caused by a collision between the UAV and a foreign object (e.g. a human being and a pet). The inflated bag in the proximity of a propeller's tip can also disrupt the tip vortex of the propeller generated in UAV operation state. The invention exhibits numerous technical merits such as enhanced operational safety, UAV drag reduction, higher propulsive efficiency, and reduction of UAV vibration level, among others.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### FIELD OF THE INVENTION

The present invention generally relates to an unmanned aerial vehicle (UAV) such as a rotorcraft and a method of improving the performance thereof. More particularly, the present invention is related to an UAV equipped with an inflated bag to prevent or alleviate property damage and personal injury caused by a collision between the UAV and a foreign object (e.g. a human being and a pet).

### BACKGROUND OF THE INVENTION

The notion of unmanned aerial flight has existed far longer than most people realize. Having received considerable news coverage since the September 11 attacks, drone use has become a common sight on the battlefield. Unmanned aerial systems (UASs) have been, and will continue to be, converted from military to civilian, educational and research applications. During this conversion, however, accidents and tragedies associated with flying drone have happened. For example, one of TGI Friday's much-hyped “Mobile Mistletoe” drones has crashed into the face of Brooklyn Daily photographer Georgine Benvenuto, clipping the end of her nose and cutting her chin with one of its spinning, uncovered blades.

In the fall of 2013, spectators gathered at the Virginia Motorsports Park for the Great Bull Run, a festival with live music, drinking, and a bull run similar to the Running of the Bulls in Spain. During the festival, a drone being used to record video crashed into the stands, injuring several people in attendance.

Accidents have also happened outside the U.S. territory. At the Geraldton Endure Batavia triathlon in Australia, a drone, piloted by local photographer Warren Abrams, was hovering about 10 meters above the race route to capture images of competitors completing the 10 km run section of the triathlon. The drone crashed into triathlete Raija Ogden, causing a head wound that required stitches to close.

The causes of these accidents may include errors in human judgment, variations in an operator's skills and situational awareness, potential air traffic controller errors, and inclement weather, all of which can be neither predicted nor utterly prevented. Understandably, the expanding purview of UASs raises valid concerns regarding safety problems, and it remains a challenge for UAS industry on how to protect innocent people from such aeronautical accidents.

Advantageously, the present invention meets the challenge, and provides a solution to overcome the drone safety problems.

### SUMMARY OF THE INVENTION

One aspect of the present invention provides an unmanned aerial vehicle (UAV) comprising (i) a frame; (ii) one or more drivers mounted on the frame; (iii) one or more propellers driven by each of the one or more drivers; (iv) a power source for the one or more drivers; (v) a functional component secured within/to the frame; and (vi) an inflated bag such as an ever-inflated bag mounted on the frame. The inflated bag is configured to decrease the probability of direct collision between a foreign object and a part of the UAV other than the inflated bag itself.

Another aspect of the invention provides a method of improving the performance of an unmanned aerial vehicle (UAV) having one or more propellers. The method comprises (1) providing an inflated bag; (2) installing the inflated bag in the proximity of a propeller's tip; and (3) disrupting tip vortex of the propeller generated in UAV operation state. In preferred embodiments, the inflated bag disrupts tip vortex only, and does not disrupt the useful vertical air flow beneath and above the propeller's body.

The above features and advantages and other features and advantages of the present invention are readily apparent from the following detailed description of the best modes for carrying out the invention when taken in connection with the accompanying drawings.

### BRIEF DESCRIPTION OF THE SEVERAL VIEWS OF THE DRAWINGS

The present invention is illustrated by way of example, and not by way of limitation, in the figures of the accompanying drawings and in which like reference numerals refer to similar elements. All the figures are schematic and generally only show parts which are necessary in order to elucidate the invention. For simplicity and clarity of illustration, elements shown in the figures and discussed below have not necessarily been drawn to scale. Well-known structures and devices are shown in simplified form in order to avoid unnecessarily obscuring the present invention. Other parts may be omitted or merely suggested.

FIG. 1 is a perspective view of a quadcopter or quadrotor as an example of the unmanned aerial vehicle (UAV) in accordance with an exemplary embodiment of the present invention.

FIG. 2 a perspective view of the quadrotor of FIG. 1 demonstrating stand bars and a bag receptacle.

FIG. 3 illustrates the working mechanism of a power source used in the quadrotor of FIG. 1 in accordance with an exemplary embodiment of the present invention.

FIG. 4 demonstrates a torus-shaped inflated bag used in UAV in accordance with an exemplary embodiment of the present invention.

FIG. 5 depicts a deviated-torus-shaped inflated bag used in the quadrotor of FIG. 1 in accordance with an exemplary embodiment of the present invention.

FIG. 6 schematically illustrates the manner how an inflated bag decreases the probability of direct collision between a foreign object and a part of the UAV other than the inflated bag itself in accordance with an exemplary embodiment of the present invention.

FIG. 7 schematically illustrates the manner how an inflated bag disrupts the tip vortex of a propeller generated in UAV operation state in accordance with an exemplary embodiment of the present invention.

FIG. 8 shows how the tip vortex of a propeller generated in UAV operation state is disrupted in different ways in accordance with an exemplary embodiment of the present invention.

FIG. 9 illustrates a solar power device in which the exterior skin of an inflated bag is used as a flexible substrate for the power device in accordance with an exemplary embodiment of the present invention.

### DETAILED DESCRIPTION OF THE PREFERRED EMBODIMENT

In the following description, for the purposes of explanation, numerous specific details are set forth in order to provide a thorough understanding of the present invention. It is apparent, however, to one skilled in the art that the present invention may be practiced without these specific details or with an equivalent arrangement.

Where a numerical range is disclosed herein, unless otherwise specified, such range is continuous, inclusive of both the minimum and maximum values of the range as well as every value between such minimum and maximum values. Still further, where a range refers to integers, only the integers from the minimum value to and including the maximum value of such range are included. In addition, where multiple ranges are provided to describe a feature or characteristic, such ranges can be combined.

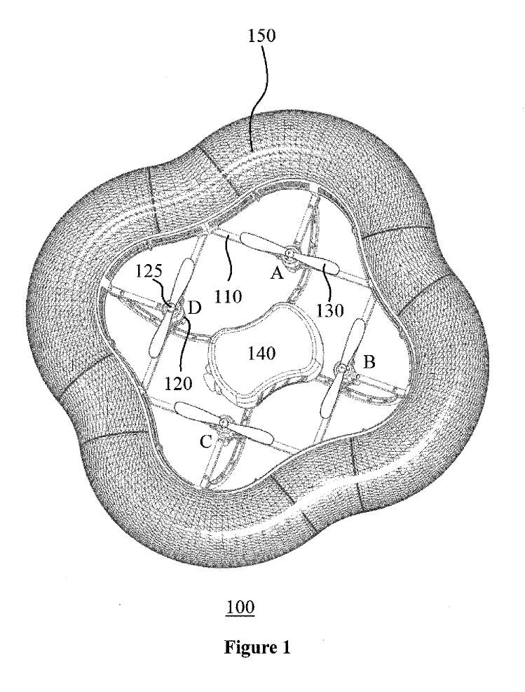

FIG. 1 shows an unmanned aerial vehicle (UAV) 100, commonly known as a drone. Although UAV 100 in FIG. 1 is illustrated as a quadcopter or quadrotor, it is contemplated that the present invention is not limited to quadcopter. UAV 100 can be any powered aerial vehicle without a human pilot aboard. In general, UAV 100 uses aerodynamic forces to provide vehicle lift, and can fly autonomously or be piloted remotely. UAV 100 of the invention can be expendable or recoverable.

The basic structural unit of UAV 100 is frame 110. Similar to the fuselage of an aircraft, the hull of a watercraft, the chassis of a car, or the skeleton of an organism, frame 110 gives UAV 100 its shape and strength and is sufficiently strong without undue deflection or distortion.

In a variety of preferred embodiments, UAV 100 is a rotorcraft that uses lift generated by rotor blade(s) or propeller(s) revolving around a mast or masts. Referring to FIG. 1, frame 110 functions as the main body section that supports and holds all other parts of UAV 100, including functional component 140, inflated bag 150 (preferably an ever-inflated bag), and one or more driver(s) 120 (e.g. 4 drivers) each of which has one or more propeller(s) 130 (e.g. 2 propellers). In FIG. 1, two propellers 130 mounted on a single mast or driveshaft 125 are referred to as a rotor, the reactions of the air on which supports UAV 100 in flight.

In more preferred embodiments of the invention, UAV 100 is a quadrotor or quadcopter. Control of UAV 100 motion can generally be achieved by varying the relative speed of each rotor to change the thrust and torque produced by each rotor. As shown in FIG. 1, UAV 100 in these embodiments may generally use two pairs of identical fixed pitched propellers 130, two revolving/spinning clockwise and the other two revolving/spinning counter-clockwise. As a matter of flight dynamics, independent variation of the speed of each rotor (labeled as A, B C and D in FIG. 1) can be used to achieve control of UAV 100. By changing the speed of each rotor, it is possible to specifically generate a desired total thrust; to locate for the center of thrust both laterally and longitudinally; and to create a desired total torque or turning force. For example, each rotor A/B/C/D produces both a thrust and torque about its center of rotation, as well as a drag force opposite to UAV 100's direction of flight. If all rotors ABCD are spinning at the same angular velocity, with rotors A and C rotating clockwise and rotors B and D counterclockwise, the net aerodynamic torque and the angular acceleration about the yaw axis are exactly zero, which enables the elimination of the tail rotor used on conventional helicopters. Yaw is induced by mismatching the balance in aerodynamic torques, i.e. by offsetting the cumulative thrust commands between the counter-rotating propeller pairs. For example, by applying equal thrust to all four rotors ABCD, UAV 100 can hover or adjust its altitude. By applying more thrust to rotors rotating in one direction (either AC or BD), UAV 100 can adjust its yaw. By applying more thrust to one rotor (e.g. A) and less thrust to its diametrically opposite rotor (e.g. C), UAV 100 can adjust its pitch or roll.

Referring again to FIG. 1, functional component 140 can be, directly or indirectly, secured or affixed within/to/onto/into frame 110. Although FIG. 1 shows that functional component 140 is a video camera, it should be appreciated that functional component 140 can be selected from a variety of payloads and devices such as a flight controller, a GPS device, an accelerometer (IMU), a sensor, a video camera, a still camera, a telescope, a military device, a cargo, a transceiver, and any combination thereof.

In an embodiment, functional component 140 may be a remote control unit for a human operator to control the flight of UAV 100. Functional component 140 can also be an onboard computer to enable UAV 100 operates autonomously, fully or intermittently. UAV actuators are another class of functional component 140, including digital electronic speed controllers (to control e.g. the RPM of a motor) linked to driver 120 such as motors/engines and propellers 130, payload actuators, LEDs, and speakers etc.

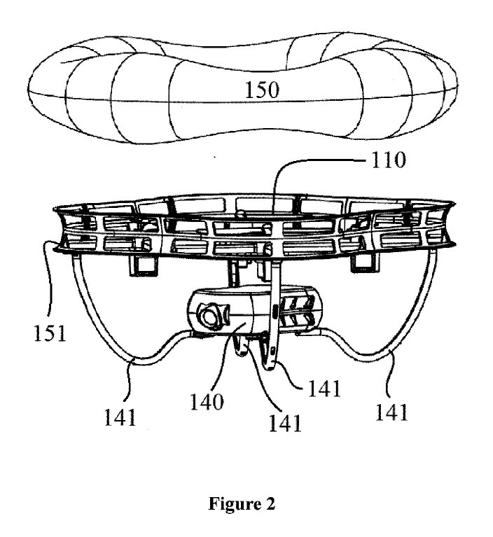

UAV 100 may include one or more landing bar(s) or stand bar(s) of any suitable shape and dimension, as part of frame 110, or as an extension structure from frame 110. FIG. 2 shows stand bars 141 as an example. In exemplary embodiments of the invention, functional component 140 may be affixed to frame 110 through stand bars 141. As shown in FIG. 2, one end of stand bar 141 is mounted on frame 110, and the other end fixedly connected to functional component 140, e.g. a video device. In a preferred embodiment, there are four stand bars 141, and they are curved shaped so as to form an umbrella-like structure.

In exemplary embodiments of the invention, inflated bag 150 is affixed to frame 110 through a circular receptacle 151 with C-shaped cross section, as shown in FIG. 2. Alternatively, part of frame 110 can be designed to function as the receptacle 151 for accommodating and securing inflated bag 150. For example, around the exterior sidewall of frame 110 can be constructed to have receptacle 151 in the form of a peripheral fillister. Inflated bag 150 can then coil around, and be secured into, the fillister.

Inflated bag 150 is preferably ever-inflated, i.e. it is permanently inflated, and it remains inflated before UVA 100 takes off, during UAV 100 flight, and after UAV 100 is landed. However, it should be appreciated that, like a tire in a car, bag 150 may be inflated and re-inflated occasionally so as to maintain a desired range of inflation pressure.

In exemplary embodiments, one or more drivers 120 is/are mounted on frame 110. Each driver 120 can drive or rotate one or more propeller(s) 130, such as two propellers 130. Driver 120 is designed to convert one form of energy into mechanical energy. Examples of driver 120 include, but are not limited to, an electric motor that converts electrical energy into mechanical motion, and a heat engine that burns a fuel to create force.

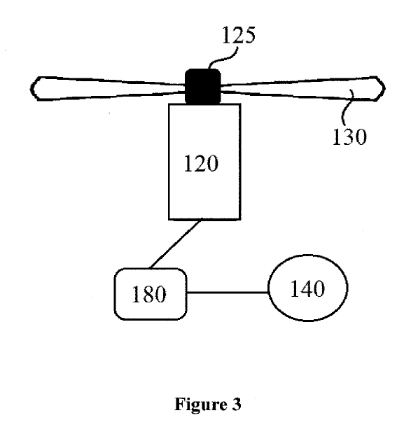

Referring to FIG. 3, a power source 180 provides energy to one or more drivers 120 for rotating propeller(s) 130. Power source 180 may be selected from a battery such as a lithium-polymer battery (Li-Po), hydrogen fuel cells, and a solar power device for driving motors; or a fuel such as gasoline for driving an engine; or any combination thereof, such as that used for a hybrid UAV. In some embodiments where power source 180 is an electrical power source, functional component 140 may share power source 180 with drivers 120. Alternatively, functional component 140 may have its separate power source.

As described above, inflated bag 150 is mounted on the frame 110. There is no specific limitation regarding the bag's shape and size. In preferred embodiments of the invention, inflated bag 150 may take the shape of a standard toroid. In mathematics, a toroid is a surface of revolution with a hole in the middle. The axis of revolution passes through the hole and does not intersect the surface. For example, when a rectangle is rotated around an axis parallel to one of its edges, then a hollow rectangle-section ring is produced. If the revolved figure is a circle, then the object is a torus, like a perfect ring donut.

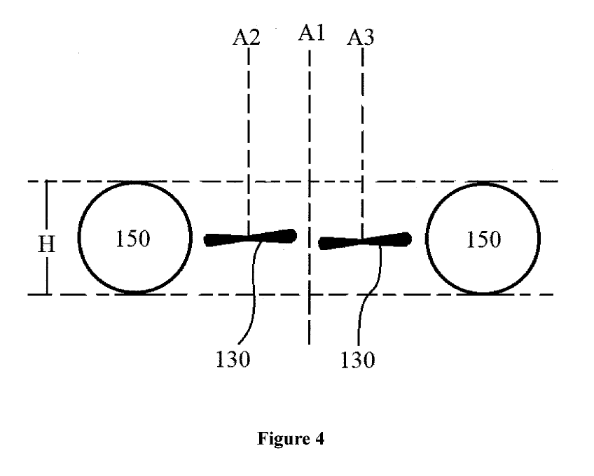

As shown in the cross sectional view in FIG. 4, inflated bag 150 is a torus that defines a hole in the middle with a vertical height H. One or more propellers 130 can be located inside the hole and within the vertical height H. In a side view of UAV 100, propellers 130 look like “buried” inside the hole, and are therefore “invisible”. As known to a skilled artisan in the field, a standard toroid has a revolution axis A1, and the one or more propellers 130 also rotate around one or more rotating axes (e.g. A2 and A3) respectively. In preferred embodiments, the revolution axis A1 of the toroid and rotating axes A2 & A3 of propellers 130 are substantially parallel to each other. The term “substantially parallel” is defined as having a less than 10° deviation (or tilt) from “absolutely parallel”.

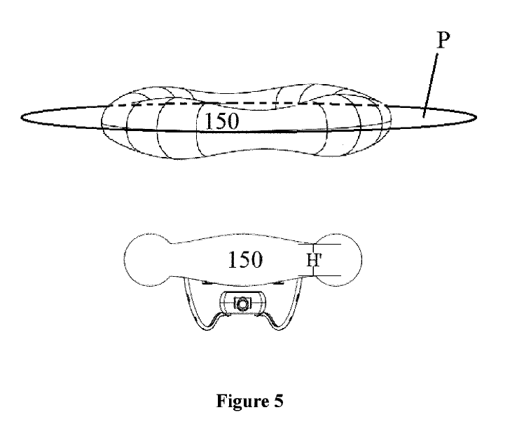

In other embodiments, inflated bag 150 may have a shape deviated from a standard toroid/torus (hereinafter deviated toroid/torus), as shown in FIGS. 1 and 5. Similar to an irregular ring donut, a deviated torus may still define a hole in the central hollow region with a minimum vertical height H′. One or more propellers 130 (not shown in FIG. 5) are located inside the hole and within the vertical height H′. In a side view of UAV 100, propellers 130 also look like “buried” into the hole, and become “invisible”. In preferred embodiments, the deviated toroid or torus is symmetrical relative to a horizontal plane P that conceptually halves inflated bag 150 like a bagel being sliced. As described above, one or more propellers 130 rotate around one or more rotating axes (not shown). These axes are, independently of each other, substantially perpendicular to the horizontal plane P. The term “substantially perpendicular” is defined as having less than 10° deviation (or tilt) from “absolutely perpendicular”.

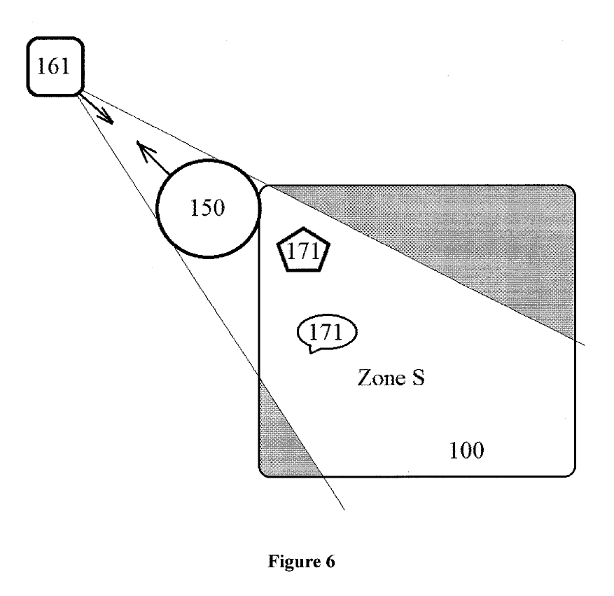

Referring to FIG. 6, a foreign object 161, UAV 100, or both, is/are moving, and the two are about to collide or crash into each other along the direction indicated by two arrows. Inflated bag 150 of the invention is configured to decrease the probability of direct collision between foreign object 161 and parts 171 of the UAV 100 other than inflated bag 150 itself, such as propeller(s) 130 and functional component 140.

As shown in FIG. 6, inflated bag 150 creates Zone S in UAV 100. In some scenarios, foreign object 161 may be a human being or a pet, and inflated bag 50 can protect the human being or pet from being injured by a part of the UAV in Zone S such as propellers, blades, or other sharp objects of UAV 100. In other scenarios, inflated bag 150 can protect the components in the Zone S from being damaged by foreign objects 161. For example, when foreign object 161 is an environmental object such as a tree, a building, a power line, or a communication line, inflated bag 150 protects parts of the UAV in Zone S from being damaged by such environmental object.

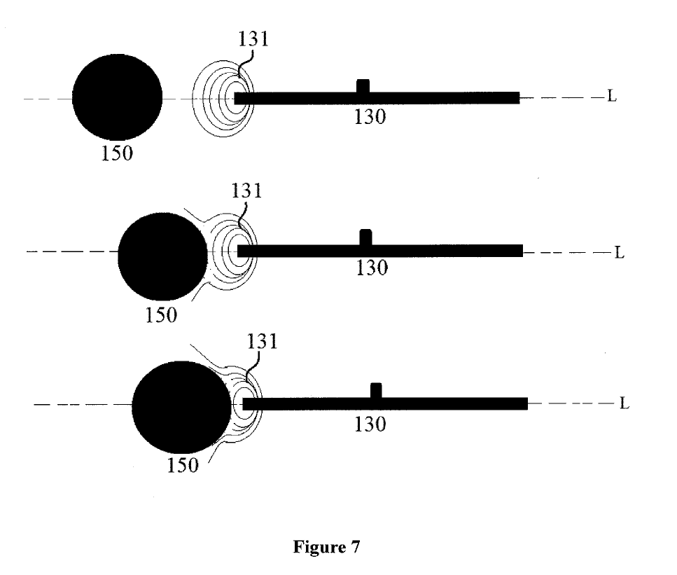

Aerodynamic surfaces produce tip vortices as an artifact of flow. For example, during typical UAV 100 flight operations, propeller 130, due to the airfoil profile and angle of attack of propeller 130, creates a high velocity low pressure field over the upper aerodynamic surface of propeller 130 and a low velocity high pressure field over the lower aerodynamic surface of propeller 130. At the tip of propeller 130, this pressure differential effectively engenders airflow circulation from the high pressure field to the low pressure field to create a tip vortex. As shown in FIG. 7, when a propeller 130 is rotating, such as in UAV 100 operation state, the propeller's tip generates a tip vortex 131. When inflated bag 150 is approaching tip vortex 131, it will disrupt the vortex more and more as the shortest distance between the two is shorter and shorter. Tip vortex 131 may be disrupted from above the propeller tip, from below the propeller tip, from sideway of the propeller tip, or any combination thereof. In preferred embodiments as shown in FIG. 7, tip vortex 131 is disrupted from sideway, i.e. bag 150 approaching vortex 131 along the extension line of propeller 130 body's longitudinal direction L.

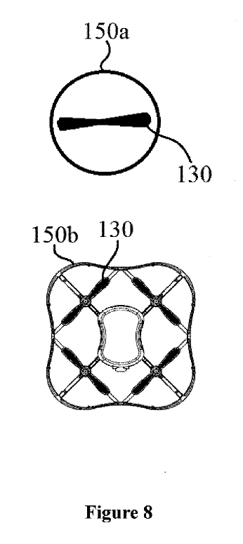

In various embodiments, inflated bag 150 may be configured to disrupt tip vortex 131 in any manners. As shown in the plan view in FIG. 8, inflated bag 150a may have a circular shape around propeller 130 so that the tip of propeller 130 maintains a constant distant from the bag 150a. Therefore, tip vortex 131 (not shown) will be disrupted equally and constantly along the rotating pathway of the tip. In other embodiments, inflated bag 150b may not have a circular shape as 150a around propeller 130, and the tip of propeller 130 cannot maintain a constant distant from the bag 150b. Therefore, tip vortex 131 (not shown) will not be disrupted equally and constantly along the rotating pathway of the tip. In other words, the closer the tip is toward bag 150b, the stronger the disruption of the tip vortex 131.

When tip vortex 131 is disrupted or reduced, UAV 100 can enjoy some technical benefits including drag reduction, downsizing of motor dimension, reduction of propeller-vortex interaction noise, improvement of propulsive efficiency, and reduction of UAV vibration level. The term “drag” is defined as the component of the total aerodynamic force parallel to the flow direction.

In various embodiments of the invention, inflated bag 150 may be filled with any gas. In preferred embodiments, it is filled or inflated with a lifting gas to create buoyancy, or to alleviate the required lift of the UAV 100. The term “lift” is defined as the component of the total aerodynamic force perpendicular to flow direction of UAV 100. For example, inflated bag 150 may be filled or inflated with a gas having a density less than 1.225 kg/m³ at sea level and at 15° C. Examples of the gas are Air, Hydrogen, Helium, Ammonia, Methane, Coal gas, Neon, Nitrogen, or any mixture thereof. In a preferred embodiment, bag 150 is inflated with air.

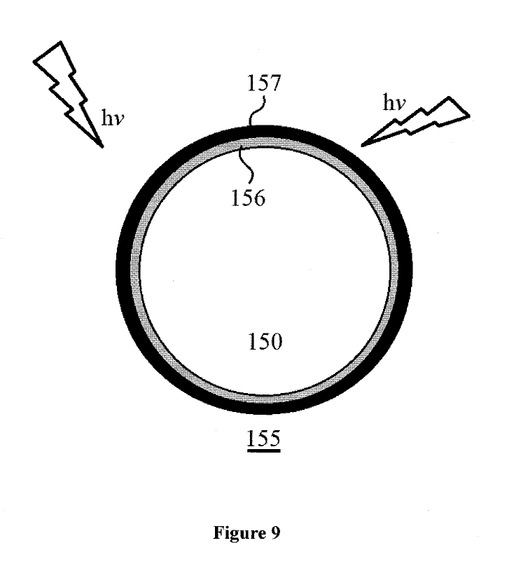

In an embodiment of the invention as shown in FIG. 9, part or all of the exterior skin 156 of inflated bag 150 can be used as the flexible substrate of a solar power device 155. The power device 155 may be the major power source 180 or a supplemental power source for UAV 100. Such a solar power device 155 may be made by depositing a photoactive layer 157 on the flexible substrate 156. Photoactive layer 157 may be designed to absorb the sun's rays as a source of energy for generating electricity. Photoactive layer 157 and other necessary layers can be deposited on a flexible substrate (e.g. an insulator such as polyester or polyimide film) by for instance monolithic integration.

UAV 100 of the present invention can be widely used in military, law enforcement, and special operation applications such as policing, reconnaissance operations, search and rescue, scouting property, locating fugitives, landslide measurement, convoy protection, border patrol missions, coordinating humanitarian aid, detecting illegal hunting and landfill, forest fire detection and monitoring, and crowd monitoring.

In many embodiments, UAV 100 of the present invention is also useful for commercial, scientific, recreational and civil applications such as surveillance, aerial filming, environment monitoring, land surveying, data collection, aerial crop surveys, aerial photography, inspection of power lines and pipelines, and logistics operation such as delivering cargo and medical supplies to otherwise inaccessible regions.

In the foregoing specification, embodiments of the present invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicant to be the scope of the invention, is the literal and equivalent scope of the set of claims that issue from this application, in the specific form in which such claims issue, including any subsequent correction.

1. An unmanned aerial vehicle (UAV) comprising:
a frame,
one or more drivers mounted on the frame, wherein each driver drives one or more propellers,
a power source for said one or more drivers,
a functional component secured within/to the frame, and
an inflated bag mounted on the frame,
wherein said inflated bag is configured to decrease the probability of direct collision between a foreign object and a part of the UAV other than the inflated bag itself.

2. The unmanned aerial vehicle according to claim 1, which is a quadrotor.

3. The unmanned aerial vehicle according to claim 1, wherein said functional component is selected from a flight controller, a GPS device, an accelerometer (IMU), a sensor, a video camera, a still camera, a telescope, a military device, a cargo, a transceiver, and any combination thereof.

4. The unmanned aerial vehicle according to claim 1, wherein said one or more drivers are a motor, an engine, or any combination thereof.

5. The unmanned aerial vehicle according to claim 1, wherein said power source comprises a battery such as lithium-polymer battery (Li-Po), a hydrogen fuel cell, a fuel, a solar power device, or any combination thereof.

6. The unmanned aerial vehicle according to claim 1, wherein said inflated bag has a shape of standard toroid, wherein the inflated bag defines a hole in the middle with a vertical height H; and wherein said one or more propellers are located inside the hole and within the vertical height H.

7. The unmanned aerial vehicle according to claim 6, wherein said standard toroid has a revolution axis, wherein said one or more propellers rotate around one or more rotating axes, and wherein said revolution axis and said one or more rotating axes are substantially parallel to each other.

8. The unmanned aerial vehicle according to claim 1, wherein said inflated bag has a shape deviated from a standard toroid; wherein the inflated bag defines a hole in the middle with a minimum vertical height H′; and wherein one or more propellers are located inside the hole and within the minimum vertical height H′.

9. The unmanned aerial vehicle according to claim 8, wherein said inflated bag is symmetrical relative to a horizontal plane that conceptually halves the inflated bag, wherein said one or more propellers rotate around one or more rotating axes, and wherein said one or more rotating axes are substantially perpendicular to said horizontal plane.

10. The unmanned aerial vehicle according to claim 1, wherein each of said propeller(s) has a propeller tip that generates a tip vortex in UAV operation state, and said inflated bag is configured to disrupt the tip vortex.

11. The unmanned aerial vehicle according to claim 10, wherein said disrupting of the tip vortex results in UAV drag reduction, downsizing of motor dimension, reduction of propeller-vortex interaction noise, improvement of propulsive efficiency, and/or reduction of UAV vibration level.

12. The unmanned aerial vehicle according to claim 1, wherein said inflated bag is filled with a lifting gas to create buoyancy, or to alleviate the required lift of the UAV.

13. The unmanned aerial vehicle according to claim 1, wherein said inflated bag is filled with a gas having a density less than 1.225 kg/m³ at sea level and at 15° C.

14. The unmanned aerial vehicle according to claim 1, wherein said inflated bag is filled with a gas selected from Air, Hydrogen, Helium, Ammonia, Methane, Coal gas, Neon, Nitrogen, or any mixture thereof.

15. The unmanned aerial vehicle according to claim 1, wherein said inflated bag is filled with air.

16. The unmanned aerial vehicle according to claim 1, wherein said part of the UAV is a propeller, said foreign object is a human being or a pet, and said inflated bag protects the human being or pet from being injured by the propeller.

17. The unmanned aerial vehicle according to claim 1, wherein said foreign object is an environmental object such as a tree, a building, a power line, or a communication line, and said inflated bag protects said part of the UAV from being damaged by the environmental object.

18. The unmanned aerial vehicle according to claim 1, wherein said power source comprises a solar power device made by depositing a photoactive layer on a flexible substrate, and wherein said flexible substrate functions as at least a part of the inflated bag exterior skin.

19. A method of improving the performance of an unmanned aerial vehicle (UAV) having one or more propellers, comprising:
(i) providing an inflated bag;
(ii) installing the inflated bag in the proximity of a propeller's tip; and
(iii) disrupting the propeller's tip vortex generated in UAV operation state.

20. The method according to claim 19, wherein said disrupting a tip vortex results in UAV drag reduction, downsizing of motor dimension, reduction of propeller-vortex interaction noise, improvement of propulsive efficiency, and/or reduction of UAV vibration level.
